(19) United States
(12) Patent Application Publication
(10) Pub. No.: US 2006/0077468 A1
(43) Pub. Date: Apr. 13, 2006

(54) System and method for smart color halftoning

(75) Inventors: Robert P. Loce, Webster, NY (US); Beilei Xu, Penfield, NY (US)

Correspondence Address: PATENT DOCUMENTATION CENTER, XEROX CORPORATION, 100 CLINTON AVE., SOUTH, XEROX SQUARE, 20TH FLOOR, ROCHESTER, NY, 14644, US

(73) Assignee: Xerox Corporation

(21) Appl. No.: 10/962,895

(22) Filed: Oct. 12, 2004

(51) Int. Cl. H04N 1/405

(52) U.S. Cl. 358/3.06

(57) ABSTRACT

A method for halftoning a color image, the color image including a plurality of color separations, includes parsing the color image into image objects; examining each image object to determine its color content; for each color separation: determining a dominant color of the image object, wherein a dominant color of an image object is determined in accordance with a predetermined relationship based on a desired output image characteristic; selecting a halftone screen property to optimize for the desired output image characteristic; and selecting a halftone screen having the halftone screen property that is optimized for the dominant image object color and the desired image output characteristic; and halftoning the image object using the selected halftone screens. Using this method, halftone screens can be optimized based on screen angle, screen offset, screen frequency and dot shape.

### CROSS-REFERENCE TO RELATED APPLICATIONS

This application is related to U.S. Pat. No. 6,643,030 filed Dec. 15, 1999, to R. Loce et al. for “Quantization Method For Color Document Reproduction In A Color Printing System” ('030 Patent), which is incorporated herein in its entirety and made a part hereof.

### BACKGROUND

This disclosure relates generally to systems and methods for selecting halftone screens, and more particularly, to a system and method for selecting an optimal halftone screen based on dominant colorant, where the optimal halftone screen selection includes characteristics such as screen angle, offset, frequency and dot shape.

In printing color documents, obtaining the desired density of a particular color is accomplished by halftoning, where separation density variation is represented by marking greater or fewer numbers of ON pixels (binary) in a distinct area of a separation. In a halftoning method known as dithering, or screening or halftoning, a value representing the density of each color separation pixel of an array of separation pixels within the area is compared to one of a set of preselected thresholds (i.e., stored as a dither matrix or halftone screen). The effect of such an arrangement is that for an area where the image density of the color separation lies between the maximum and minimum levels, some of the thresholds within the dither matrix will be exceeded while others will not. In the binary case, the separation pixels for which the thresholds are exceeded might be printed as a maximum colorant value, while the remaining separation pixels are allowed to remain white, dependent on the actual physical quantity described by the data.

While widely accepted as a method for rendering color prints of digital images, halftoning and the resulting halftone dot pattern can sometimes create image quality problems. For instance, when a halftone dot pattern is used to render edges in text and other objects with fine detail, the halftone structure may cause edge raggedness. Also, when halftone color separations are superimposed over other halftone color separations in a multiple color separation image, moiré and other pattern artifacts can occur.

Reduction of pattern artifacts consumes a great deal of effort when designing halftone screens for a printer or other image output device. Much effort has been spent on techniques to avoid pattern artifacts when printing multiple separation color halftones; however, some undesirable patterns still remain and can be found in commonly printed material. For example, the interaction of the Y (yellow) and K (black) separations can cause particularly noticeable moiré defects, and have since been suppressed to some extent. The '030 PATENT describes a method for suppressing Y and K moiré artifacts by causing the Y and K separations to be printed using halftone screens for those separations having the same halftone angles as other color separations. This solution, where a halftone angle is shared by more than one color, produces good results, but requires additional halftone screens.

Most conventional halftoning assumes that four colors (colorants) will be printed and halftone screen angles are selected accordingly. The choice of halftone angles is frequently less than optimal for many 1- 2-, and 3-color (colorant) objects because of resulting pattern artifacts (such as moiré or edge jaggedness) that could have been avoided if the halftone screen angles had been selected knowing that a given object consisted of 1, 2, or 3 dominant colorants. Graphic artists often select halftone screen angles based on the color and subject content of an image to avoid these undesirable patterns. This process involves selection of halftone angles by an expert manually.

In addition to pattern artifacts caused by halftone screen angles, pattern artifacts can be caused by less than optimal selection of other characteristics of the halftone screens used for multicolor printing. For example, halftone screen offset, screen frequency and dot shape are known to produce unwanted pattern artifacts due to less than optimal selection of these halftone screen characteristics for multi-color objects. It would be desirable to have a halftone screen selection process that could be utilized by non-experts, performed within an image path (i.e., automatically), and localized to individual objects within a page.

### SUMMARY

A method for halftoning a color image, the color image including a plurality of color separations, according to one embodiment, includes parsing the color image into image objects; examining each image object to determine its color content; for each color object: determining a dominant colorant of the image object, wherein a dominant colorant of an image object is determined in accordance with a predetermined relationship based on a desired output image characteristic; selecting a halftone screen property to optimize for the desired output image characteristic for the image class; and selecting a halftone screen having the halftone screen property that is optimized for the dominant image object colorant and the desired image output characteristic; and halftoning the image object using the selected halftone screens. The halftone screen property may be any one of halftone screen angle, halftone screen offset, halftone screen frequency and dot shape. Color content may be analyzed for image objects, clusters of images or a whole page based on an aggregate analysis. In accordance with another embodiment, the color image may be parsed into image classes, such as text and pictorials. By parsing the image into image classes, image classes such as pictorials and large areas of tint can have a halftone screen selected for moiré reduction. Similarly, image classes such as text, other line art, and tints with well-defined edges can have a halftone screen selected to reduce edge raggedness.

The method for halftoning a color image may be applied to dot-off-dot printing method. For color smart dot-off-dot printing the color-to-color misregistration performance of a machine should be known, that is, for a given machine, its actual performance may be different from its specification-defined performance. For a measured misregistration distance, a halftone frequency can be chosen such that the dots will not change their amount of colorant-to-colorant overlap if the dots were moved anywhere over that misregistration distance. It is easiest to think of a highlight color where there are small dots and lots of white space. There are some printing situations where it would be advantageous for one set of colorant dots be positioned at the same angle and frequency as another set of colorant dots without any overlap for any misregistration that could occur within the expected registration performance. In these situations dot-off-dot printing may be used where the same screen angles and frequencies are used for more than one colorant.

A method for halftoning a color image, the color image including a plurality of color separations, according to another embodiment, includes parsing the color image into image objects (or, optionally, image class); examining each image object to determine its color content; for each color object: determining a dominant colorant of the image object; and selecting an initial halftone screen having a halftone screen angle that is optimized for the dominant image object colorant and image class if a screen frequency is preselected; determining a dot separation distance between dots printed in one color and dots printed in another color using the initial halftone screens; if the dot separation distance is greater than a misregistration specification of an output device, selecting a halftone screen having a halftone screen angle and a halftone screen offset that compensates (i.e., dots will not change their amount of colorant-to-colorant overlap if the dots are moved anywhere within the misregistration distance) for the difference between the dot separation distance and the misregistration specification; and halftoning the image object using the selected halftone screens.

A halftoning system, for use in a reproduction device printing a plurality of separations, according to another embodiment, includes a separation input, receiving said plurality of separations for printing, each separation representing a distinct printer colorant, and including a plurality of image signals described; a parsing circuit for parsing the color image into image objects; a memory storing a plurality of halftone screens; a color analysis module for examining each image object to determine its color content; for each color object: for determining a dominant colorant of the image object, wherein a dominant colorant of an image object is determined in accordance with a predetermined relationship based on a desired output image characteristic; and for selecting a halftone screen property to optimize for the desired output image characteristic; and a halftone selection module for selecting a halftone screen from memory having the halftone screen property that is optimized for the dominant image object colorant and the desired image output characteristic; and a halftoner for halftoning the image object using the selected halftone screens. The system may further include a tag generator, responsive to the color analysis module, for generating a tag based on image object color content; and wherein the halftone selection module is further responsive to the generated tag. It should be noted that in many cases, a system will select a halftone screen stored in memory. However, as pixel resolution increases it may become easier for a system to have a separate module for designing halftone screens on the fly. Thus, the halftone selection step could trigger creation of the appropriate halftone or extraction of an existing one from memory.

The method and system may be used to automatically select optimal or near optimal halftone angles for image objects within an image path setting to reduce undesirable textures and edge jaggedness for most 1- 2- and 3-color objects. The system and method examines an object within an image for its color content (or optionally uses any associated tag which may identify the object's color) to automatically select a desired halftone screen property, such as halftone screen angles, halftone offset, dot shape or halftone frequency for the object, and then performs the halftoning based on the selection. The result is a print with less undesirable texture and edge jaggedness than conventional halftone systems that was produced without expert intervention. The method and system can be used to improve tag encoding efficiency, multiple screen storage efficiency, or preferred computation partitioning between software and hardware.

### BRIEF DESCRIPTION OF THE DRAWINGS

FIG. 1 is a block diagram of a halftoning system;

FIG. 2 is a schematic of a halftoned color image formed from screens for two colors and printed using conventional halftoning techniques;

FIG. 3 is a schematic of the same image shown in FIG. 2 printed using a method for halftoning described herein;

FIG. 4 is a schematic of text printed using conventional halftoning;

FIG. 5 is a schematic of the same text shown in FIG. 4 printed using a method for halftoning described herein;

FIG. 6 is a schematic of dispersion in a printed output using rotated dot screens;

FIG. 7 is a schematic of dot-off-dot printing using a halftone screen offset;

FIG. 8 is a schematic of a hole centered rosette; and

FIG. 9 is a schematic of a dot centered rosette.

### DETAILED DESCRIPTION

An image path that utilizes contone data and tags at one or more stages can be complicated, because image manipulation and analysis can be partitioned across modules in a variety of ways. This complexity makes it difficult to describe one canonical image path that fully describes all embodiments of the system and method. A method for halftoning a color image parses an input image into image objects and each image object is evaluated to determine its color content. Alternatively, color content may be analyzed for color classes such as text and pictorials, an image cluster or a whole page, based on an aggregate analysis. By parsing the image into image classes, image classes such as pictorials and large areas of tint can have a halftone screen selected for moiré reduction. Similarly, image classes such as text, other line art, and tints with well-defined edges can have a halftone screen selected to reduce edge raggedness. By parsing the image into image clusters, the image cluster could be used to pick halftone screen attributes for a collection of images or pages, when new screens can only be swapped in for a complete print job, and not swapped in for individual image objects. The color content is then examined to determine a dominant colorant based on a predetermined relationship which depends on desired output characteristics.

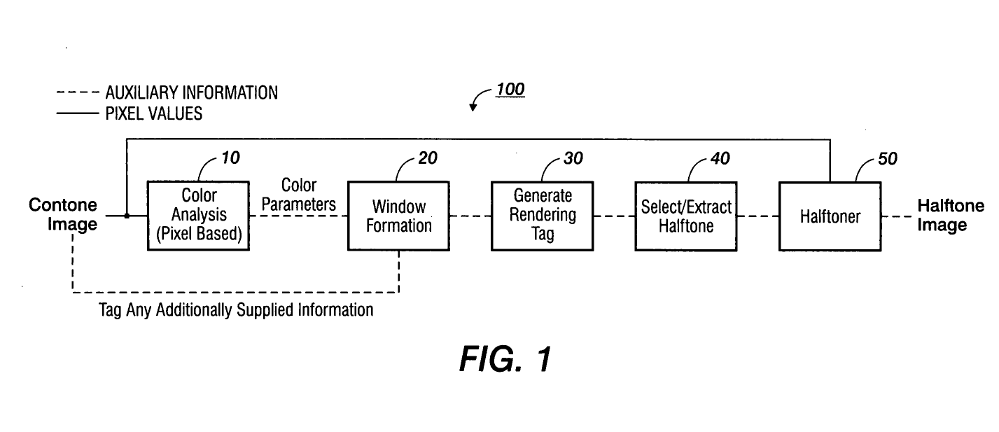

Referring to FIG. 1, an exemplary image path 100 is shown. A contone image (from an image object, image cluster or other convenient image category) is provided to a color evaluation module 10. The contone image objects are examined to determine the number of colorants that will be used to make the object (e.g., a green object can be made of cyan and yellow). Either the nonzero colorants are determined or dominant colorants are determined. The “examination of color content” in its simplest form looks for image objects that are not composed of four colors. For instance, it is useful to determine if an object is red, green, blue, cyan, magenta, or yellow. Besides pure, uniform colored objects, it is useful to determine one or more colorants are dominant in an object. For instance, it is useful to determine if an object is a portrait with a lot of magenta. Several rules or predetermined relationships for determining dominant colorants are described in the '030 Patent directed toward optimal Y screen selection, and those rules may be generalized for selecting screen angles for any colorant.

In addition to the relationships described in the '030 Patent, a blue sky or a portrait can be said to possess dominant colorants of cyan and magenta respectively, because, those colorants form an important image feature. These object types can be determined in a segmentation/classification process that looks for broad expanses of cyan or magenta, while other colorants are weakly represented. More generally, any colorant that possesses a strong value over a broad expanse while other colorants are weak may be considered dominant. If it is determined that the desired halftone screen property is screen angle, dominant colorants may be given preferred screen angles. A converse to the above rule can be developed using lack of broad expanse to determine colorants that do not need a critical screen angle.

Colorant density along image edges can also be used to determine dominance. For instance an image that possess a lot of strong edges at one orientation for a given colorant would benefit from a halftone that is oriented to optimally render those edges. The edges could be within the picture, such as lines that form the edges of buildings, or the edges could be the border of the picture or object, such as the edges of text. Image class can be used to drive the selection of the dominance criterion, and hence the selection of screens. For example, for an image class consisting of text/line art, sharp edges are more important than moiré while vice versa for pictorial images.

The input image (and image objects) may be defined in several ways. For instance, it may be defined via operators and operator parameters in a Page Description Language form. Also, it may be a collection of pixels in a digital image possessing a same or equivalent tag (identifier). Referring again to FIG. 1, input pixels may be provided to pixel-based color analysis 12. In digital images, such object pixels are often clustered into spatial blocks, often referred to as windows, but they may also be isolated individual pixels at dispersed locations in an image. Spatial blocks of pixels would be formed in window formation block 13. The object could be defined at several possible locations in an image path, for instance, by a user in an image editing software application, by image processing in a scanner (e.g., DigiPath® software), by image processing in a raster image processor (RIP).

Similar to operations for defining an object, examination of an object for its colorant content could take on different forms depending on the image path architecture. In some settings it may be most advantageous to view the object color by examination of color definitions in a Page Description Language (PDL) form of the object. A tag for subsequent halftone selection could be generated from such definitions in tag block 20. The tagging could also be performed by examining pixels in a digital image.

Optionally, a tag may be generated which can be used in halftone selection based on the color content. There are several tagging schemes that may be used depending on the desired property (e.g., minimal number of tag states, minimal number of halftones, any subsequent processing, etc.). An understanding of the tag generation and its utilization are tightly coupled to the halftone screen selection process. There are several useful tag-generation and utilization schemes. Some methods may be desirable for reasons of reduced memory requirements. Other methods may use special properties of the image path such as the ability to flip halftones to different angles, or the ability to perform further examination of the image. Limitations of the image path or imaging device may also influence the particular tag utilization method. In the examples below, several possible tag generation/utilization schemes are described. In the examples below, the set of all possible dominant colorant combinations are determined, and for a given halftone screen property (in this case, halftone screen angle), tags are assigned to each colorant combination and corresponding desired halftone screen angles. It should be noted, however, that the use of tags is not required; tags are a customary technique in digital imaging of providing information to the printer.

If sufficient information is contained in a tag, the tag can be used to select a halftone screen. In some cases partial information may be in the tag and an additional view of the object may be needed to select the halftone screen.

Examples of tagging and halftone angle selection schemes. The examples below were constructed with rules having the following goals: minimize the visibility and edge patterns of a single dominant colorant by placing its screen at 45° and minimize moiré and edge patterns of multiple dominant colorants.

The following is an exemplary set of rules which may be used in designing a “color-smart” halftone screen set (other rule sets are possible):
For one dominant colorant, orient the halftone screen angle at 45° unless it is Y, where the angle is not critical.
For two dominant colorants: separate the halftone screen angles by 45°.
For three dominant colorants: separate the halftone screen angles by 30°.
For four dominant colorants: use classical halftone screen angles.

Given the above rules there are two factors to consider when defining an optimal halftone screen set. One factor is to use the least amount of storage for the halftones (this may not be important in all printer applications). Another factor is to use the fewest tag states. In the examples given below, we make the classical assumption that the screen frequencies are roughly equal and that maximum angular separation is preferred.

First consider all possible dominant colorant combinations in a four color system, which can be represented by a maximum of 16 possible states.

TABLE 1
A list of all possible dominant colorant combinations in a
conventional four color printing system.

| State | Dominant Colorants |
|---|---|
| 0 | C |
| 1 | M |
| 2 | Y |
| 3 | K |
| 4 | YC |
| 5 | YM |
| 6 | YK |
| 7 | CM |
| 8 | CK |
| 9 | MK |
| 10 | YCM |
| 11 | YCK |
| 12 | YMK |
| 13 | CMK |
| 14 | CMYK |
| 15 | None |

TABLE 2
An example using a maximum of 3 halftone screens per colorant.

Dominant colorants

| | Y | C | M | K |
|---|---|---|---|---|
| Single colorant or | 90° | 45° | 45° | 45° |
| Single colorant + Y | | | | |
| States 0-6 | | | | |
| C or M with K | | 90° | 90° | 45° |
| States 8, 9 | | | | |
| CM | | 90° or 45° | 45° or 90° | |
| State 7 | | | | |
| C or K with MY | 15° | 45° | 75° | 45° |
| States 10, 12 | | | | |
| CKY | 75° | 15° | | 45° |
| State 11 | | | | |
| CMK or CMYK | 90° | 15° | 75° | 45° |
| States 13, 14 | | | | |

In Table 2, the first column shows the possible tag states (dominant colorant states), where the state number shown is number used in Table 1, and each row corresponds to the optimal screen selection for the specific tag state. In this case, the 16 states shown in Table 1 are reduced down to 6 states indicated by the 6 rows. For some states screen angle choices can be made between the dominant colorants depending on relative density or image content. For example in the third row, if C or M is more critical than K, K may be placed at 90° and C or M may be placed at 45°.

TABLE 3
An example using a maximum of 6 screens per colorant to avoid
objectionable artifacts due to the 90°screen.

Dominant colorants

| | Y | C | M | K |
|---|---|---|---|---|
| Single colorant or | 90° | 45° | 45° | 45° |
| Single colorant + Y | | | | |
| States 0-6 | | | | |
| C or M with K | | 67.5° | 67.5° | 22.5° |
| States 8, 9 | | | | |
| CM | | 22.5° | 67.5° | |
| State 7 | | | | |
| C or K with MY | 90° | 30° | 60° | 30° |
| States 10, 12 | | | | |
| CKY | 90° | 60° | | 30° |
| State 11 | | | | |
| CMK or CMYK | 90° | 15° | 75° | 45° |
| States 13, 14 | | | | |

The screen set in Table 3 avoids a 90° screen for the darker colors (CMY) because 90° screens tend to be sensitive to sources of banding, such as photoreceptor velocity modulation.

There are several approaches to further reduce the amount of storage for halftone screens. For example, when screens can be flipped about an axis in real time, only one screen from the symmetric pairs (e.g. 15° to 75°, 30° to 60°, 22.5° to 67.50°) needs to be stored (see for example U.S. Pat. No. 6,208,430 for “Increased Functionality For Holladay Halftoning” and U.S. Pat. No. 6,262,811 for “Increased Functionality For Holladay Halftoning” assigned to the assignee of this application, the contents of which are incorporated herein by reference and made a part hereof).

By using this approach, the maximum number of screens required for each colorant can be reduced down to 4 in Table 3.

Once the desired halftone screens are identified, they may be extracted from memory and used to perform the halftoning. Alternatively, once the desired screen characteristics are identified, the desired halftone screens may be generated “on the fly”. The creation could be by known techniques, such as sampling analytic functions that describe a “halftone spot function” that possesses the desired characteristics.” An example of spot function generation may be found in co-assigned U.S. Pat. No. 4,196,451 to Ronald Pellar for “Electronic Halftone Generato” and U.S. Pat. No 4,149,183 to Ronald Pellar et al for “Electronic Halftone Generator.”

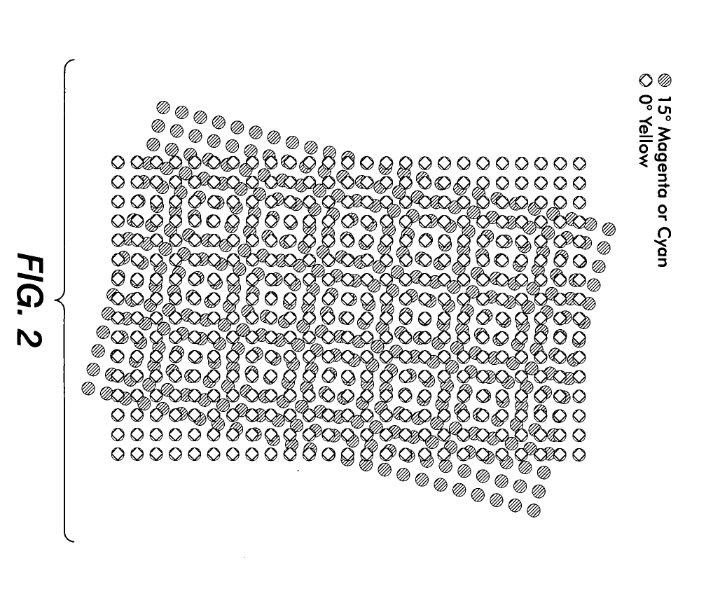

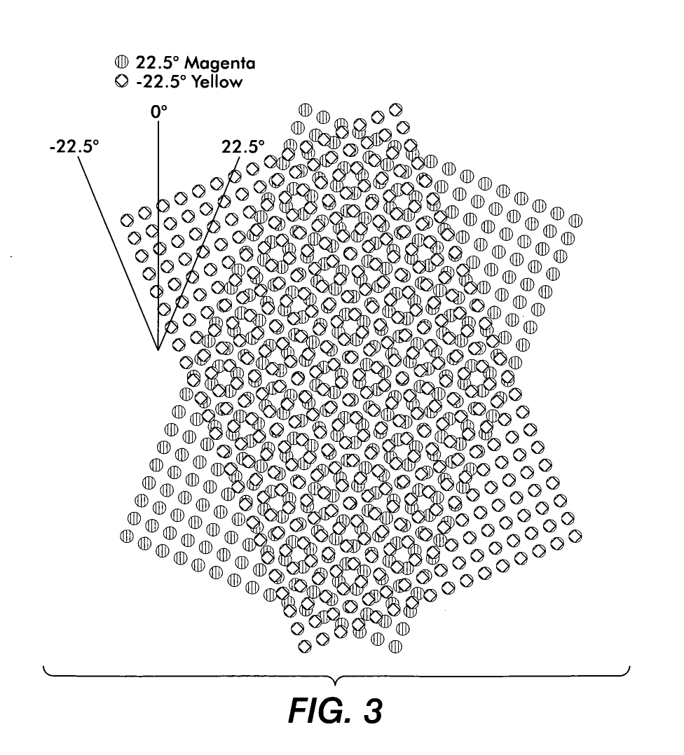

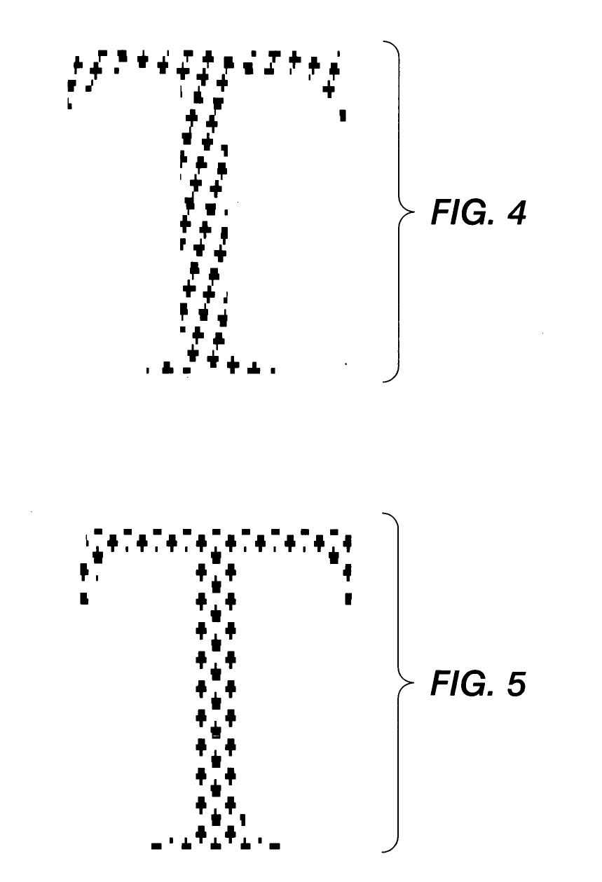

FIGS. 2 and 3 show a schematic of tinted halftones produced with conventional halftoning and halftoning based on optimized halftone screen angle selection, respectively. Notice the smoother texture of FIG. 3. FIGS. 4 and 5 show a schematic of cyan or magenta tinted halftoned text created with conventional halftoning and halftoning based on optimized halftone screen angle selection, respectively. The halftone dot pattern of FIG. 4 is what would occur when a conventional screen angle for cyan or magenta is used. Notice the significant improvement in edge raggedness in the color-smart prints of FIG. 5.

In addition to selection based on halftone screen angle, the system and method for halftoning can also be used to select optimized halftone screens based on other halftone screen properties such as halftone screen offset, frequency and dot shape. It should be noted that a halftone screen may be optimized with respect to more than one halftone screen property. For example, once optimized halftone screen angles have been selected, then an optimized screen offset may be selected. Optimizing screen offset can be used to achieve better image texture. System architecture is the same as shown in FIG. 1. Two embodiments of color smart offset selection are described below in more detail.

Color Smart dot-off-dot printing: Lithographic and xerographic printers typically have separation-to-separation registration specifications of roughly 85-100 microns, which is on the order of a few 600 spi pixels. Since the location of color separations typically cannot be controlled to a tighter tolerance, lithographic and xerographic printers typically use a halftoning method that is relatively insensitive to separation-to-separation misregistration. This method, known as rotated dot screening, is illustrated in FIG. 5. In the figure note that misregistering the two color planes in any direction will result in roughly the same fraction of each of the following toner coverage: white (no toner), cyan, magenta, and cyan/magenta overlap. Maintaining the ratio of these four toner coverages for the various misregistrations maintains the average color value. This color stability is obtained at the price of a relatively coarse texture and jaggedness of the edge of the tint. The combined halftone structure produces frequencies in the texture and in the jagged edges that are about half of the frequency of the individual halftone separations. This is undesirable because lower frequencies are more visible and distracting to the observer.

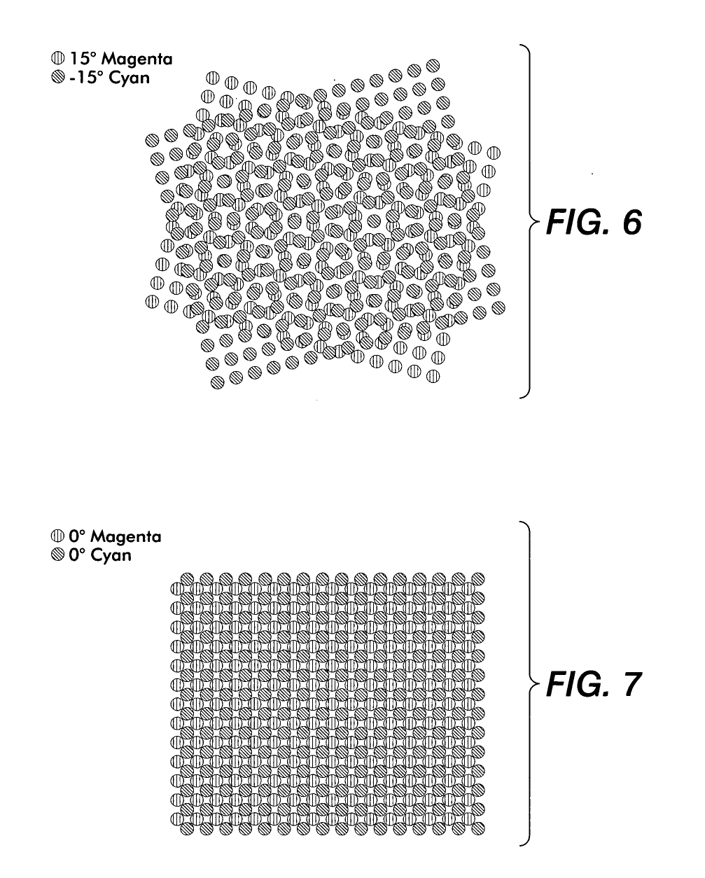

If separation-to-separation registration is very tight (≈10 microns) for a given printer, as in some ink jet printers, a halftoning method known as dot-off-dot halftoning may be used (FIG. 6). Interdigitization of the halftones shown in FIG. 6, in effect, doubles the visually apparent frequency for a two-colorant object. The texture looks smoother, and edges look sharper. But a small amount of misregistration could significantly alter the ratio of the various coverages, thereby producing a significant color shift.

Using the Color Smart method, examine the color of an image object and determine if the dots can be printed to achieve the desired color without overlapping. That is, for screens at a particular angle determine if a dot separation distance can be used that is near or greater than the misregistration specification of the printer. For the determined color, if the dots can be separated by an amount greater than the possible misregistration, then an angle and offset can be chosen for the screens that achieves dot-off-dot printing.

Consider the following example. We wish to print a highlight blue color at 141 cpi using 600 spi pixels and an 80 micron registration specification. For a blue requiring ≦1 pixel of cyan and ≦1 pixel of magenta, the angles for cyan and magenta can be chosen to be same, say 45° (using the rules described above for halftone angle selection), and the offset between the screens can be one half period of the halftone. In this example, the separation-to-separation misregistration would not change the ratio of the coverages and advantages of dot-off-dot halftoning can be realized through the angle and offset selection.

An extension to this concept is to selection of halftone frequency based on color selection. Suppose the above dot distance analysis was performed for a particular halftone frequency and it was determined that for a given frequency the potential misregistration could vary the coverages, and thus the screen angles and offsets for dot-off-dot printing were not appropriate. A decision could be made to select a lower frequency screen that meets the dot-distance criterion because a somewhat lower frequency screen printed dot-off-dot could look more pleasing than a higher frequency screen printed using rotated dots.

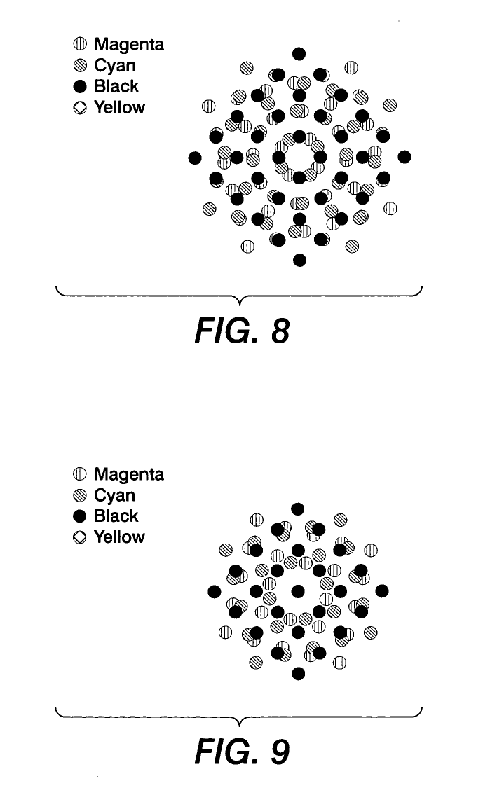

Some users prefer a rosette structure for rotated halftones for images that are primarily light or primarily dark and possess a range of colors that does not allow dot-off-dot printing. Consider the two rosette structures shown in FIGS. 7 and 8. The structure shown in FIG. 7 is known as a hole-centered rosette. For many marking processes it forms a preferred texture for highlight colors. It is formed by utilizing rotated halftone screens that are offset so that the centers of the white portion of the halftone cells are coincident. The structure shown in FIG. 8 is known as a dot-centered rosette. For many marking processes it forms a preferred texture for dark colors. It is formed by utilizing rotated halftone screens that are offset so that the centers of the dots of the halftone cells are coincident. While preference for hole-centered or dot-centered rosettes do not always follow the above rules for all printers and subject matter, for a given marking process there does tend to be a preferred rosette structure for most images.

The color smart method analyzes the color of an image object, and if rotated screens are to be used, a screen offset can be chosen that selects the desired rosette for that object. For instance, if the object was a light color and a given printer produced pleasing texture with hole-centered rosettes for light colors, then offsets would be applied to the halftone screens such that the holes of the halftone cells would be coincident.

In addition to selection based on halftone screen angle and screen offset, the system and method for halftoning can also be used to select optimized halftone screens based on halftone screen properties such as halftone screen frequency and dot shape.

Screen Frequency: One example of color smart selection of screen frequency was given above in the dot-off-dot example. Another example concerns moiré. A particular screen set may be moiré free for many colors, but suffers from moiré for some other colors. When the problem colors are to be printed, the system and method could be modified to select a halftone screen set that does not possess moiré for those colors.

Dot Shape: The dot shape corresponds to the thresholds or spot function used to create the dots. Although it is more subtle than the above examples, some dot shapes can be preferred for some colors. For example, if the colors of an object could be produced with dots that are nontouching circles, then a circular spot function is desirable. This is opposed to an image object that spans a range of colors that necessitates some touching of dots. In that case the dots must be formed in a way that creates stable touch points with pleasing textures. A similar situation occurs for dark colors and holes. If the range of the colors is all dark, where holes will not touch, the holes can be shaped as circles. If the range of colors requires that some holes touch, then the holes must be shaped to have stable touch points.

The set of conventional 4-colorants (CMYK) was used in many of the above examples because their familiarity aids in readily teaching the concepts. But, they are indeed only examples of colorants that can be used with the disclosed method and system. For example “high fidelity” printing that uses additional colorants, such as orange, green, and red, as well as other high fidelity printing would benefit from the present invention. Examples of high fidelity applications can be found in U.S. Pat. No. 6,307,645 to David Mantell et al for “Halftoning For Hi-Fi Color Inks,” U.S. Pat. No. 5,892,891 to Edul Dalal et al for “System For Printing Color Images With Extra Colorants In Addition To Primary Colorants,” and U.S. Pat. No. 5,870,530 to Raja Balasubramanian for “System For Printing Color Images With Extra Colorants In Addition To Primary Colorants.”

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

What is claimed is:

1. A method for halftoning a color image, the color image including a plurality of color separations, comprising:
parsing the color image into image objects;
examining each image object to determine its color content;
for each color object:
determining a dominant colorant of the image object, wherein a dominant colorant of an image object is determined in accordance with a predetermined relationship based on a desired output image characteristic;
selecting a halftone screen property to optimize for the desired output image characteristic; and
selecting a halftone screen having the halftone screen property that is optimized for the dominant image object colorant and the desired image output characteristic; and
halftoning the image object using the selected halftone screens.

2. The method of claim 1, wherein the color separations include cyan, magenta, yellow and black.

3. The method of claim 1, wherein the halftone screen property comprises halftone screen angle.

4. The method of claim 1, wherein the halftone screen property comprises halftone screen offset.

5. The method of claim 1, wherein the halftone screen property comprises halftone screen frequency.

6. The method of claim 1, wherein the halftone screen property comprises dot shape.

7. The method of claim 1, further comprising:
prior to selecting the halftone screen property, generating a tag based on image object color content; and
selecting a halftone screen based on the generated tag and having the halftone screen property that is optimized for the dominant image object color and the desired image output characteristic.

8. The method of claim 1, wherein the predetermined relationship is based on color content, desired output image characteristics and image object type.

9. The method of claim 1, wherein the predetermined relationship is based on color content and image features.

10. The method of claim 1, wherein the predetermined relationship is based on colorant density along image object edges.

11. A method for halftoning a color image, the color image including a plurality of color separations, comprising:
parsing the color image into image objects;
examining each image object to determine its color content;
for each color separation:
determining a dominant colorant of the image object; and
selecting an initial halftone screen having a halftone screen angle that is optimized for the dominant image object colorant;
determining a dot separation distance between dots printed in one colorant and dots printed in another colorant using the initial halftone screens;
if the dot separation distance is greater than a misregistration specification of an output device, selecting a halftone screen having a halftone screen angle and a halftone screen offset that compensates for the difference between the dot separation distance and the misregistration specification; and
halftoning the image object using the selected halftone screens.

12. The method of claim 11, wherein the selected halftone screens comprise rotated halftone screens offset from one another to provide a desired rosette structure.

13. The method of claim 12, wherein the desired rosette structure comprises a dot centered rosette.

14. The method of claim 12, wherein the desired rosette structure comprises a hole centered rosette.

15. The method of claim 11, further comprising: selecting a lower frequency halftone screen that meets the dot-distance criterion.

16. The method of claim 6, wherein the selected halftone screen produces dots formed of non-touching circles.

17. The method of claim 6, wherein the selected halftone screen produces dots formed of touching circles.

18. A halftoning system, for use in a reproduction device printing a plurality of separations comprising:
a separation input, receiving said plurality of separations for printing, each separation representing a distinct printer colorant, and including a plurality of image signals described;
a parsing circuit for parsing the color image into image objects;
a memory storing a plurality of halftone screens;
a color analysis module for examining each image object to determine its color content; for each color separation:
for determining a dominant colorant of the image object, wherein a dominant colorant of an image object is determined in accordance with a predetermined relationship based on a desired output image characteristic; and
for selecting a halftone screen property to optimize for the desired output image characteristic; and
a halftone selection module for selecting a halftone screen from memory having the halftone screen property that is optimized for the dominant image object colorant and the desired image output characteristic; and
a halftoner for halftoning the image object using the selected halftone screens.

19. The system of claim 18, further comprising:
a tag generator, responsive to the color analysis module, for generating a tag based on image object color content; and
wherein the halftone selection module is further responsive to the generated tag.

20. The system of claim 18, the halftone screen property comprises one of halftone screen angle, halftone screen offset, halftone screen frequency and dot shape.

21. A method for halftoning a color image, the color image including a plurality of color separations, comprising:
parsing the color image into image classes;
examining each image class to determine its color content;
for each image class:
determining a dominant colorant of the image class, wherein a dominant colorant of an image class is determined in accordance with a predetermined relationship based on a desired output image characteristic;
selecting a halftone screen property to optimize for the desired output image characteristic; and
selecting a halftone screen having the halftone screen property that is optimized for the dominant image object colorant and the desired image output characteristic; and
halftoning the image class using the selected halftone screens.

22. The method of claim 21, wherein the color separations include cyan, magenta, yellow and black.

23. The method of claim 21, wherein the color separations include orange, green and red.
